(19) United States
(12) Patent Application Publication
(10) Pub. No.: US 2022/0236452 A1
(43) Pub. Date: Jul. 28, 2022

(54) Method For Classification Of Precipitation Type Based On Deep Learning

(71) Applicant: SI Analytics Co., Ltd., Daejeon (KR)

(72) Inventor: Yeji CHOI, Daejeon (KR)

(73) Assignee: SI Analytics Co., Ltd., Daejeon (KR)

(21) Appl. No.: 17/580,286

(22) Filed: Jan. 20, 2022

(30) Foreign Application Priority Data
Jan. 27, 2021 (KR) 10-2021-0011524

(51) Int. Cl. G01W 1/14; G06N 3/08; G01S 13/95

(52) U.S. Cl. CPC G01W 1/14; G01S 13/95; G06N 3/08

(57) ABSTRACT

According to an exemplary embodiment of the present disclosure, a method of classifying a precipitation type based on deep learning performed by a computing device is disclosed. The method may include: receiving first sensor data and second sensor data measured in a satellite; and generating training data based on at least a part of the first sensor data overlapping the second sensor data.

### CROSS-REFERENCE TO RELATED APPLICATIONS

This application claims priority to and the benefit of Korean Patent Application No. 10-2021-0011524 filed in the Korean Intellectual Property Office on Jan. 27, 2021, the entire contents of which are incorporated herein by reference.

### TECHNICAL FIELD

The present disclosure relates to an image processing method, and more particularly, to a deep learning technology for distinguishing a precipitation type that is one of meteorological characteristics by using a satellite observation result.

### BACKGROUND ART

In meteorological observational studies, it is important to understand various different characteristics of precipitation. For example, precipitation characteristics may be typified according to the mechanisms generally associated with vertical air motion. As such, the precipitation characteristics that may be typified according to different physical characteristics may be analyzed based on the microwave observation results using satellites.

There are various prior studies that attempt to classify precipitation types using microwave observations. One of the representative prior studies is based on statistical and empirical approaches. For example, in microwave satellite observations, variability in emission and scatter signals is used to statistically classify precipitation types. However, these methods do not guarantee high accuracy, and thus have a problem in that precipitation types are not effectively classified.

Korean Patent Application Laid-Open No. 10-2009-0131564 (Dec. 29, 2009) discloses a system and a method of analyzing weather satellite data based on a web.

### SUMMARY OF THE INVENTION

The present disclosure has been conceived in response to the foregoing background art, and has been made in an effect to provide method of classifying a precipitation type that is one of meteorological characteristics by using a satellite observation result based on deep learning.

In order to solve the foregoing object, an exemplary embodiment of the present disclosure discloses a method of classifying a precipitation type based on deep learning performed by a computing device. The method may include: receiving first sensor data and second sensor data measured in a satellite; and generating training data based on at least a part of the first sensor data overlapping the second sensor data.

In an alternative exemplary embodiment, the second sensor data may include data measured within a swath in a relatively narrower range than the first sensor data.

In the alternative exemplary embodiment, the first sensor data may include data measured through a microwave image sensor of a Global Precipitation Measurement (GPM) satellite. And the second sensor data may include data measured through a Dual-frequency Precipitation Radar (DPR) sensor.

In the alternative exemplary embodiment, the generating of the training data based on at least a part of the first sensor data overlapping the second sensor data may include: overlapping the first sensor data and the second sensor data based on an observation location for each pixel of the second sensor data; and generating the training data based on at least a part of the first sensor data that have overlapped based on the observation location for each pixel of the second sensor data.

In the alternative exemplary embodiment, the generating of the training data based on at least a part of the first sensor data overlapping the second sensor data may further include generating a subset of the training data based on a ratio of pixels in which precipitation exists included in the training data.

In the alternative exemplary embodiment, the training data may include: a first input characteristic representing a brightness temperature derived from at least a part of the first sensor data overlapping the second sensor data; and a second input characteristic representing a ground surface type derived from the second sensor data.

In the alternative exemplary embodiment, the first input characteristic may include information about the brightness temperature divided based on a measurement frequency and a polarization direction of the first sensor data.

In the alternative exemplary embodiment, the ground surface type may include at least one of marine, land, coast, and in-land water.

In the alternative exemplary embodiment, the training data may be labeled with information about a precipitation type derived from the second sensor data.

In the alternative exemplary embodiment, the precipitation type includes at least one of: a first type representing no rain; a second type representing stratiform rain; a third type representing convective rain; and a fourth type representing cloud or noise.

In the alternative exemplary embodiment, the method may further include training a deep learning model so as to classify the precipitation type for each pixel based on the training data.

In order to solve the foregoing object, another exemplary embodiment of the present disclosure discloses a method of classifying a precipitation type based on deep learning performed by a computing device. The method may include: receiving sensor data measured in a satellite, and classifying a precipitation type for each pixel based on the sensor data by using a pre-trained deep learning model.

In an alternative exemplary embodiment, the deep learning model may be pre-trained based on first sensor data measured in the satellite and second sensor data measured within a swath in a relatively narrower range than the first sensor data.

In order to solve the foregoing object, another exemplary embodiment of the present disclosure discloses a computer program stored in a computer readable storage medium. When the computer program is executed by one or more processors, the computer program may perform following operations for classifying a precipitation type based on deep learning, the operations including: receiving a first sensor data and a second sensor data measured in a satellite; and generating training data based on at least a part of the first sensor data overlapping the second sensor data.

In order to solve the foregoing object, another exemplary embodiment of the present disclosure discloses a computing device for classifying a precipitation type based on deep learning. The computing device may include: a processor including at least one core; a memory including program codes executable in the processor; and a network unit configured to receive sensor data measured in a satellite, in which the processor generates training data based on at least a part of first sensor data measured in a satellite, the first sensor data overlapping second sensor data measured in the satellite.

In order to solve the foregoing object, another exemplary embodiment of the present disclosure discloses a computer readable recording medium in which a data structure corresponding to processed data related to a training process updating at least a part of parameters of a neural network is stored. An operation of the neural network may be at least partially based on the parameter, and a method of processing the data may include: receiving first sensor data and second sensor data measured in a satellite; and generating training data based on at least a part of the first sensor data overlapping the second sensor data.

The present disclosure may provide a method of classifying the precipitation type that is one of the meteorological characteristics by using a satellite observation result based on deep learning.

### BRIEF DESCRIPTION OF THE DRAWINGS

FIG. 1 is a block diagram of a computing device for classifying a precipitation type based on deep learning according to an exemplary embodiment of the present disclosure.

FIG. 2 is a schematic diagram illustrating a network function according to the exemplary embodiment of the present disclosure.

FIG. 3 is a block diagram illustrating a process of training a deep learning model for classifying a precipitation type according to the exemplary embodiment of the present disclosure.

FIG. 4 is a conceptual diagram illustrating sensor data measured in a satellite according to the exemplary embodiment of the present disclosure.

FIG. 5 is a conceptual diagram illustrating a verification result of the deep learning model according to the exemplary embodiment of the present disclosure.

FIG. 6 is a flowchart illustrating a process of training the deep learning model by a computing device according to the exemplary embodiment of the present disclosure.

FIG. 7 is a flowchart illustrating a process of classifying a precipitation type by using the deep learning model of the computing device according to the exemplary embodiment of the present disclosure.

FIG. 8 is a schematic diagram illustrating a computing environment according to an exemplary embodiment of the present disclosure.

### DETAILED DESCRIPTION

Various exemplary embodiments are described with reference to the drawings. In the present specification, various descriptions are presented for understanding the present disclosure. However, it is obvious that the exemplary embodiments may be carried out even without a particular description.

Terms, “component”, “module”, “system”, and the like used in the present specification indicate a computer-related entity, hardware, firmware, software, a combination of software and hardware, or execution of software. For example, a component may be a procedure executed in a processor, a processor, an object, an execution thread, a program, and/or a computer, but is not limited thereto. For example, both an application executed in a computing device and a computing device may be components. One or more components may reside within a processor and/or an execution thread. One component may be localized within one computer. One component may be distributed between two or more computers. Further, the components may be executed by various computer readable media having various data structures stored therein. For example, components may communicate through local and/or remote processing according to a signal (for example, data transmitted to another system through a network, such as the Internet, through data and/or a signal from one component interacting with another component in a local system and a distributed system) having one or more data packets.

A term “or” intends to mean comprehensive “or” not exclusive “or”. That is, unless otherwise specified or when it is unclear in context, “X uses A or B” intends to mean one of the natural comprehensive substitutions. That is, when X uses A, X uses B, or X uses both A and B, “X uses A or B” may be applied to any one among the cases. Further, a term “and/or” used in the present specification shall be understood to designate and include all of the possible combinations of one or more items among the listed relevant items.

It should be understood that a term “include” and/or “including” means that a corresponding characteristic and/or a constituent element exists. Further, a term “include” and/or “including” means that a corresponding characteristic and/or a constituent element exists, but it shall be understood that the existence or an addition of one or more other characteristics, constituent elements, and/or a group thereof is not excluded. Further, unless otherwise specified or when it is unclear in context that a single form is indicated, the singular shall be construed to generally mean “one or more” in the present specification and the claims.

The term “at least one of A and B” should be interpreted to mean “the case including only A”, “the case including only B”, and “the case where A and B are combined”.

Those skilled in the art shall recognize that the various illustrative logical blocks, configurations, modules, circuits, means, logic, and algorithm operations described in relation to the exemplary embodiments additionally disclosed herein may be implemented by electronic hardware, computer software, or in a combination of electronic hardware and computer software. In order to clearly exemplify interchangeability of hardware and software, the various illustrative components, blocks, configurations, means, logic, modules, circuits, and operations have been generally described above in the functional aspects thereof. Whether the functionality is implemented as hardware or software depends on a specific application or design restraints given to the general system. Those skilled in the art may implement the functionality described by various methods for each of the specific applications. However, it shall not be construed that the determinations of the implementation deviate from the range of the contents of the present disclosure.

The description about the presented exemplary embodiments is provided so as for those skilled in the art to use or carry out the present disclosure. Various modifications of the exemplary embodiments will be apparent to those skilled in the art. General principles defined herein may be applied to other exemplary embodiments without departing from the scope of the present disclosure. Therefore, the present disclosure is not limited to the exemplary embodiments presented herein. The present disclosure shall be interpreted within the broadest meaning range consistent to the principles and new characteristics presented herein.

In the present disclosure, a network function, an artificial neural network, and a neural network may be interchangeably used.

In the meantime, the term “sensor data” used throughout the present description and claims of the present disclosure refers to multidimensional data composed of discrete image elements (for example, pixels in a two-dimensional image), and in other words, is a term referring to a visible object (for example, displayed on a video screen) or a digital representation (such as a file corresponding to a pixel output) of the object.

The term “precipitation” used throughout the description and claims of this disclosure may be understood as a meteorological term meaning anything that water vapor condenses and falls on the ground during the Earth's water cycle. For example, in addition to rain and snow, so-called sleet, and dew can also be included in precipitation in addition to hail.

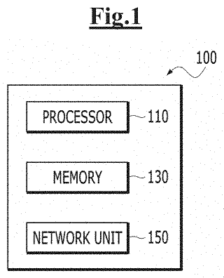

FIG. 1 is a block diagram of a computing device for classifying a precipitation type based on deep learning according to an exemplary embodiment of the present disclosure.

The configuration of a computing device 100 illustrated in FIG. 1 is merely a simplified example. In the exemplary embodiment of the present disclosure, the computing device 100 may include other configurations for performing a computing environment of the computing device 100, and only some of the disclosed configurations may also configure the computing device 100.

The computing device 100 may include a processor 110, a memory 130, and a network unit 150.

The processor 110 may be formed of one or more cores, and may include a processor, such as a central processing unit (CPU), a general purpose graphics processing unit (GPGPU), and a tensor processing unit (TPU) of the computing device, for performing a data analysis and deep learning. The processor 110 may read a computer program stored in the memory 130 and process data for machine learning according to an exemplary embodiment of the present disclosure. According to the exemplary embodiment of the present disclosure, the processor 110 may perform calculation for training a neural network. The processor 110 may perform a calculation, such as processing of input data for training in Deep Learning (DL), extraction of a feature from input data, an error calculation, and updating of a weight of the neural network by using backpropagation, for training the neural network. At least one of the CPU, GPGPU, and TPU of the processor 110 may process training of a network function. For example, the CPU and the GPGPU may process training of the network function and data classification by using a network function together. Further, in the exemplary embodiment of the present disclosure, the training of the network function and the data classification by using a network function may be processed by using the processors of the plurality of computing devices together. Further, the computer program executed in the computing device according to the exemplary embodiment of the present disclosure may be a CPU, GPGPU, or TPU executable program.

According to the exemplary embodiment of the present disclosure, the processor 110 may train a deep learning model so as to classify a precipitation type of a specific earth surface region based sensor data measured in a satellite. The processor 110 may perform pre-processing on the plurality of sensor data measured in the satellite, and then input training data generated through the pre-processing to the deep learning model to train the deep learning model so as to classify the precipitation type of the region of interest. In this case, the plurality of sensor data measured in the satellite may include first sensor data including an earth surface image generated through microwave observation and second sensor data including an earth surface image measured within a swath of a relative narrower range compared to the first sensor data. The swath may be understood as a distance to the earth surface perceived during one sweeping of the scanning reflector in satellite or aerial laser surveying.

For example, the processor 110 may collocate the first sensor data and the second sensor data together by overlapping the first sensor data and the second sensor data, of which the swaths are different due to the different scanning methods, based on a scan line. The processor 110 may find the closest observation location for each pixel of the second sensor data and overlap the first sensor data and the second sensor data. The processor 110 may generate training data based on at least a part of the first sensor data overlapping the second sensor data. That is, the processor 110 may generate training data by aligning the data based on the observation location of each pixel constituting the sensor data and merging the sensor data of different swaths. In this case, some of the information included in the first sensor data and the information included in the second sensor data may be used as input characteristics of the training data, and some of the information included in the second sensor data may be used as a label of the training data. That is, the processor 110 may label some of the information included in the second sensor data to the first sensor data, and merge the two different sensor data to generate the training data. The processor 110 may train the deep learning model so as to classify the precipitation type for each pixel based on the information labeled to the training data.

The processor 110 may classify the precipitation type based on the sensor data measured in the satellite by using the deep learning model pre-trained through the foregoing process. The processor 110 may classify the precipitation type for the region of interest by inputting the sensor data measured in the satellite to the deep learning model. In this case, the precipitation type may include at least one of a first type representing no-rain, a second type representing stratiform rain, a third type representing convective rain, and a fourth type representing cloud or noise. For example, the processor 110 may determine whether precipitation exists for each pixel of the earth surface image measured through the sensor provided in the satellite, and if there is precipitation, what characteristic of precipitation is the precipitation, and whether the precipitation is not precipitation but is a cloud or noise by using the deep learning model. In this case, the earth surface image input for the inference operation that is the classification of the precipitation type of the deep learning model may correspond to the first sensor data between the first sensor data and the second sensor data.

According to the exemplary embodiment of the present disclosure, the memory 130 may store a predetermined type of information generated or determined by the processor 110 and a predetermined type of information received by a network unit 150.

According to the exemplary embodiment of the present disclosure, the memory 130 may include at least one type of storage medium among a flash memory type, a hard disk type, a multimedia card micro type, a card type of memory (for example, an SD or XD memory), a Random Access Memory (RAM), a Static Random Access Memory (SRAM), a Read-Only Memory (ROM), an Electrically Erasable Programmable Read-Only Memory (EEPROM), a Programmable Read-Only Memory (PROM), a magnetic memory, a magnetic disk, and an optical disk. The computing device 100 may also be operated in relation to web storage performing a storage function of the memory 130 on the Internet. The description of the foregoing memory is merely illustrative, and the present disclosure is not limited thereto.

The network unit 150 according to the exemplary embodiment of the present disclosure may use a predetermined form of a publicly known wire/wireless communication system.

The network unit 150 may receive the sensor data measured in the satellite from an external system. For example, the network unit 150 may receive the earth surface image from an artificial satellite system, an aviation system, a ground database server, and the like. The earth surface image may be the data for training or the data for inference of the deep learning model. The earth surface image in which the object of interest (for example, the specific region of the earth surface) is photographed may include the image photographed through the microwave sensor provided in the artificial satellite, an airplane, and the like. The earth surface image in which the object of interest is expressed is not limited to the foregoing example, and may be variously configured within the range understandable by those skilled in the art.

The network unit 150 may transceive information processed by the processor 110, the user interface, and the like through communication with other terminals. For example, the network unit 150 may provide the user interface generated by the processor 110 to a client (for example, a user terminal). Further, the network unit 150 may receive the external input of the user applied to the client and transfer the received external input to the processor 110. In this case, the processor 110 may process the operations of output, correction, change, addition, and the like of the information provided through the user interface based on the external input of the user received from the network unit 150.

In the meantime, the computing device 100 according to the exemplary embodiment of the present disclosure is a computing system for transceiving information with the client through communication and may be a server. In this case, the client may be a predetermined type of terminal accessible to the server. For example, the computing device 100 that is the server may receive the ground photographed image from the artificial satellite system and classify the precipitation type, and provide a user interface based on a result of the classification to the user terminal. In this case, the user terminal may output the user interface received from the computing device 100 that is the server, and receive or process information through interaction with the user.

In an additional exemplary embodiment, the computing device 100 may also include a predetermined form of terminal which receives data resources generated in a predetermined server and performs additional information processing.

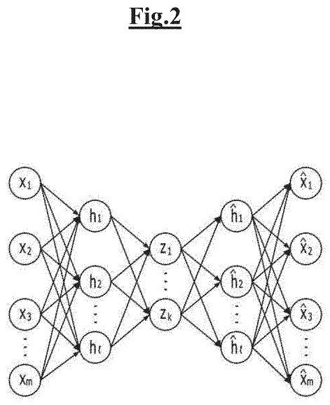

FIG. 2 is a schematic diagram illustrating a network function according to the exemplary embodiment of the present disclosure.

The deep learning model according to the exemplary embodiment of the present disclosure may include a neural network for classifying the precipitation type. Throughout the present specification, a nerve network, a network function, and the neural network may be used with the same meaning. The neural network may be formed of a set of interconnected calculation units which are generally referred to as “nodes”. The “nodes” may also be called “neurons”. The neural network consists of one or more nodes. The nodes (or neurons) configuring the neural network may be interconnected by one or more links.

In the neural network, one or more nodes connected through the links may relatively form a relationship of an input node and an output node. The concept of the input node is relative to the concept of the output node, and a predetermined node having an output node relationship with respect to one node may have an input node relationship in a relationship with another node, and a reverse relationship is also available. As described above, the relationship between the input node and the output node may be generated based on the link. One or more output nodes may be connected to one input node through a link, and a reverse case may also be valid.

In the relationship between an input node and an output node connected through one link, a value of the output node data may be determined based on data input to the input node. Herein, a link connecting the input node and the output node may have a weight. The weight is variable, and in order for the neural network to perform a desired function, the weight may be varied by a user or an algorithm. For example, when one or more input nodes are connected to one output node by links, respectively, a value of the output node may be determined based on values input to the input nodes connected to the output node and weights set in the link corresponding to each of the input nodes.

As described above, in the neural network, one or more nodes are connected with each other through one or more links to form a relationship of an input node and an output node in the neural network. A characteristic of the neural network may be determined according to the number of nodes and links in the neural network, a correlation between the nodes and the links, and a value of the weight assigned to each of the links. For example, when there are two neural networks in which the numbers of nodes and links are the same and the weight values between the links are different, the two neural networks may be recognized to be different from each other.

The neural network may consist of a set of one or more nodes. A subset of the nodes configuring the neural network may form a layer. Some of the nodes configuring the neural network may form one layer based on distances from an initial input node. For example, a set of nodes having a distance of n from an initial input node may form n layers. The distance from the initial input node may be defined by the minimum number of links, which need to be passed to reach a corresponding node from the initial input node. However, the definition of the layer is arbitrary for the description, and a degree of the layer in the neural network may be defined by a different method from the foregoing method. For example, the layers of the nodes may be defined by a distance from a final output node.

The initial input node may mean one or more nodes to which data is directly input without passing through a link in a relationship with other nodes among the nodes in the neural network. Otherwise, the initial input node may mean nodes which do not have other input nodes connected through the links in a relationship between the nodes based on the link in the neural network. Similarly, the final output node may mean one or more nodes that do not have an output node in a relationship with other nodes among the nodes in the neural network. Further, the hidden node may mean nodes configuring the neural network, not the initial input node and the final output node.

In the neural network according to the exemplary embodiment of the present disclosure, the number of nodes of the input layer may be the same as the number of nodes of the output layer, and the neural network may be in the form that the number of nodes decreases and then increases again from the input layer to the hidden layer. Further, in the neural network according to another exemplary embodiment of the present disclosure, the number of nodes of the input layer may be smaller than the number of nodes of the output layer, and the neural network may be in the form that the number of nodes decreases from the input layer to the hidden layer. Further, in the neural network according to another exemplary embodiment of the present disclosure, the number of nodes of the input layer may be larger than the number of nodes of the output layer, and the neural network may be in the form that the number of nodes increases from the input layer to the hidden layer. The neural network according to another exemplary embodiment of the present disclosure may be the neural network in the form in which the foregoing neural networks are combined.

A deep neural network (DNN) may mean the neural network including a plurality of hidden layers, in addition to an input layer and an output layer. When the DNN is used, it is possible to recognize a latent structure of data. That is, it is possible to recognize latent structures of photos, texts, videos, voice, and music (for example, what objects are in the photos, what the content and emotions of the texts are, and what the content and emotions of the voice are). The DNN may include a convolutional neural network (CNN), a recurrent neural network (RNN), an auto encoder, Generative Adversarial Networks (GAN), a restricted Boltzmann machine (RBM), a deep belief network (DBN), a Q network, a U network Siamese network, and the like. The foregoing description of the deep neural network is merely illustrative, and the present disclosure is not limited thereto.

In the exemplary embodiment of the present disclosure, the network function may include an auto encoder. The auto encoder may be one type of artificial neural network for outputting output data similar to input data. The auto encoder may include at least one hidden layer, and the odd-numbered hidden layers may be disposed between the input/output layers. The number of nodes of each layer may decrease from the number of nodes of the input layer to an intermediate layer called a bottleneck layer (encoding), and then be expanded symmetrically with the decrease from the bottleneck layer to the output layer (symmetric with the input layer). The auto encoder may perform a nonlinear dimension reduction. The number of input layers and the number of output layers may correspond to the dimensions after preprocessing of the input data. In the auto encoder structure, the number of nodes of the hidden layer included in the encoder decreases as a distance from the input layer increases. When the number of nodes of the bottleneck layer (the layer having the smallest number of nodes located between the encoder and the decoder) is too small, the sufficient amount of information may not be transmitted, so that the number of nodes of the bottleneck layer may be maintained in a specific number or more (for example, a half or more of the number of nodes of the input layer and the like).

The neural network may be trained by at least one scheme of supervised learning, unsupervised learning, semi-supervised learning, and reinforcement learning. The training of the neural network may be a process of applying knowledge for the neural network to perform a specific operation to the neural network.

The neural network may be trained in a direction of minimizing an error of an output. In the training of the neural network, training data is repeatedly input to the neural network and an error of an output of the neural network for the training data and a target is calculated, and the error of the neural network is back-propagated in a direction from an output layer to an input layer of the neural network in order to decrease the error, and a weight of each node of the neural network is updated. In the case of the supervised learning, training data labelled with a correct answer (that is, labelled training data) is used, in each training data, and in the case of the unsupervised learning, a correct answer may not be labelled to each training data. That is, for example, the training data in the supervised learning for data classification may be data, in which category is labelled to each of the training data. The labelled training data is input to the neural network and the output (category) of the neural network is compared with the label of the training data to calculate an error. For another example, in the case of the unsupervised learning related to the data classification, training data that is the input is compared with an output of the neural network, so that an error may be calculated. The calculated error is back-propagated in a reverse direction (that is, the direction from the output layer to the input layer) in the neural network, and a connection weight of each of the nodes of the layers of the neural network may be updated according to the backpropagation. A change amount of the updated connection weight of each node may be determined according to a learning rate. The calculation of the neural network for the input data and the backpropagation of the error may configure a learning epoch. The learning rate is differently applicable according to the number of times of repetition of the learning epoch of the neural network. For example, at the initial stage of the learning of the neural network, a high learning rate is used to make the neural network rapidly secure performance of a predetermined level and improve efficiency, and at the latter stage of the learning, a low learning rate is used to improve accuracy.

In the training of the neural network, the training data may be generally a subset of actual data (that is, data to be processed by using the trained neural network), and thus an error for the training data is decreased, but there may exist a learning epoch, in which an error for the actual data is increased. Overfitting is a phenomenon, in which the neural network excessively learns training data, so that an error for actual data is increased. For example, a phenomenon, in which the neural network learning a cat while seeing a yellow cat cannot recognize cats, other than a yellow cat, as cats, is a sort of overfitting. Overfitting may act as a reason of increasing an error of a machine learning algorithm. In order to prevent overfitting, various optimizing methods may be used. In order to prevent overfitting, a method of increasing training data, a regularization method, a dropout method of inactivating a part of nodes of the network during the training process, a method using a bath normalization layer, and the like may be applied.

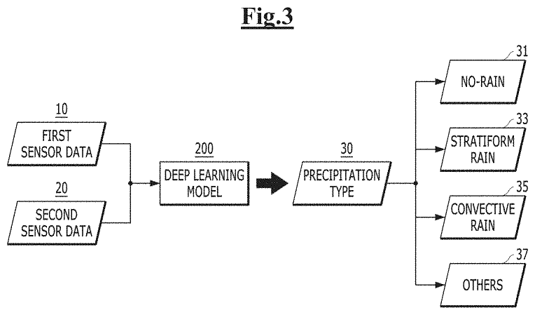

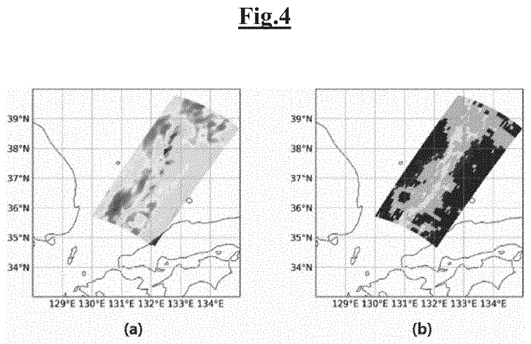

FIG. 3 is a block diagram illustrating a process of training a deep learning model for classifying a precipitation type according to the exemplary embodiment of the present disclosure. Further, FIG. 4 is a conceptual diagram illustrating sensor data measured in a satellite according to the exemplary embodiment of the present disclosure.

Referring to FIG. 3, a deep learning model 200 according to the exemplary embodiment of the present disclosure may receive training data generated from sensor data photographed trough a satellite. In this case, the training data may be generated based on first sensor data 10 measured through a microwave sensor provided in the satellite and second sensor data 20 measured within a swath of a relative narrower range compared to the first sensor data 10. The training data may be generated based on at least a part of the first sensor data 10 overlapping the second sensor data 20.

For example, the first sensor data 10 may include data measured through a microwave image sensor of a Global Precipitation Measurement (GPM) satellite (hereinafter, referred to as a “GMT”). The GMT is a manual microwave radiometer having a conical-scanning swath of 904 km, and is used for detecting the amount of precipitation. In the meantime, the second sensor data 20 may include data measured through a Dual-frequency Precipitation Radar (DPR) sensor. The DPR sensor provides 5 km resolution footprint having an original cross-track swath of 245 km and 120 km in a specific frequency band (ku and ka bands). Herein, the footprint may be understood as a projection pattern drawn on one area of the earth or the earth surface that the satellite can cover at a remote detection unit altitude.

Since the GMI and the DPR sensor have different scanning methods, the GMI has 221 pixels in one scan line with a 904 km swath, but the DPR sensor has 49 pixels in one scan line with a 245 km swath. Therefore, in order to use the GMI-based first sensor data 10 and the DPR sensor-based second sensor data 20 together, an operation of matching the scales between the two data 10 and 20 is required. The processor 110 according to the exemplary embodiment of the present disclosure may match the scales between the two data 10 and 20 by overlapping the GMI-based first sensor data 10 and the second sensor data 20 based on the observation location for each pixel of the DPR sensor-based second sensor data 20. In particular, the processor 110 may find the closest observation location of each pixel constituting the second sensor data 20 and collocating the second sensor data 20 and the first sensor data 10 together, to match the scales between the two data 10 and 20. FIG. 4 illustrates an example of sensor data of which the scales are matched. (a) of FIG. 4 represents the GMI data observed with a horizontal parallel plate channel of 89 GHz, and (b) of FIG. 4 represents the DPR sensor data of the region corresponding to the region of interest represented in (a).

The training data generated based on the first sensor data 10 and the second sensor data 20 which are measured within the different swaths may include a first input characteristic representing a brightness temperature derived from at least a part of the first sensor data 10 overlapping the second sensor data 20, and a second input characteristic representing a ground surface type derived from the second sensor data 20. Further, the training data may include information about the precipitation type derived from the second sensor data 20 as a label.

In particular, the first input characteristic may include information about the brightness temperature divided based on a measured frequency and a polarization direction of the first sensor data 10. The first input characteristic may include information about a brightness temperature based on a dual polarization channel in a frequency domain of each of 10 GHz, 19 GHz, 37 GHz, and 89 GHz, and information about a brightness temperature based on a single polarization channel in 23 GHz. Further, the first input characteristic may include information about a brightness temperature based on a Polarization Corrected Temperature (PCT) channel in a frequency region of each of 10 GHz, 19 GHz, 37 GHz, and 89 GHz. In this case, the PCT may be understood as a linear combination of the brightness temperatures for reducing the change in the earth surface characteristic. In the meantime, the channel-related numerical values are one example for describing the first input characteristic, and may be changed within the range understandable by those skilled in the art.

In consideration of the fact that the brightness temperature representing the first input characteristic is varied according to the ground surface type due to the difference in the irradiation rate of the earth surface according to the ground surface type, the training data may include the second input characteristic for the ground surface type. In this case, the ground surface type is meta information included in the DPR sensor-based second sensor data 20, and include at least one of marine, land, coast, and in-land water.

The information about the precipitation type labeled on the training data is meta information included in the DPR sensor-based second sensor data 20, and represents the precipitation type for each of the pixels included in the region of interest. The precipitation type may be generally divided based on whether precipitation exists in a specific pixel. When the precipitation exists in the specific pixel, the precipitation type may be divided into stratiform rain, convective rain, or noise. Therefore, each pixel configuring the training data may include one of the four precipitation types derived from the second sensor data 20 as a label. The deep learning model 200 may perform learning by using one of the four precipitation types labeled on each pixel of the training data as ground truth (GT).

In the meantime, the processor 110 may generate a subset of the training data based on a ratio of the pixels in which the precipitation exists included in the training data for the smooth training of the deep learning model 200. In general, there is inevitably an information imbalance in the sensor data itself for a specific region due to weather conditions, environment, and the like at the time at which the data is measured in the satellite. Therefore, in order to solve the imbalance, the processor 110 may generate a subset for dividing the training data generated through the foregoing process based on a ratio of the pixels in which the precipitation exists. For example, the processor 110 may configure a first subset including one or more pixels in which the precipitation exists based on a specific region. The processor 110 may configure a second subset so that the pixels in which the precipitation exists based on the specific region occupies 10% or more of the entire pixels. The processor 110 may configure a third subset so that the pixels in which the precipitation exists based on the specific region occupies 50% or more of the entire pixels. The processor 110 may configure the three types of subsets of the training data and use for training the deep learning model 200.

The deep learning model 200 may receive the training data generated based on the first sensor data 10 and the second sensor data 20 or the subset of the training data and perform the learning of classifying the precipitation type 30 for each pixel of the training data. For example, the deep learning model 200 may receive the subset of the training data, and classify the precipitation type 30 into any one of no rain 31, stratiform rain 33, convective rain 35, and other precipitation 37 for each pixel configuring the subset. The deep learning model 200 may learn the precipitation type 30 for each pixel by comparing the classification result for each pixel with the label for each pixel included in the subset.

In order to classify the precipitation type 30, the deep learning model 200 according to the exemplary embodiment of the present disclosure may include at least one of a first neural network performing semantic segmentation based on a convolution layer, and a second neural network based on a fully-connected multilayer. The first neural network may receive the training data including the first input characteristic and the second input characteristic and classify the precipitation type 30 through output channels for each class to which the same weight is applied. Further, the second neural network may receive the training data including the first input characteristic and the second input characteristic and classify the precipitation type 30 for each pixel. When the deep learning model 200 includes both the first neural network and the second neural network, the deep learning model 200 may derive a final classification result by ensembling the outputs of the respective neural networks.

For example, the first neural network may perform semantic segmentation that connects each pixel configuring the training data to a class label, and include a U-NET which is capable of preserving spatial information in the training process. The first neural network that is the U-NET includes three down-sampling and up-sampling blocks, and three convolution layers may be included in each block. The first neural network that is the U-NET may include a bottleneck layer including two convolution layers. For the training through the first neural network, a categorical cross-entropy loss function may be used. Further, a Rectified Linear Unit (ReLU) may be used as an active function, and an Adaptive moment estimation (Adam) may be used as an optimizer. In the meantime, the particular numerical value of the first neural network is merely one example for helping the understanding, and is not limited thereto.

The second neural network may include a Deep Neural Network (DNN) consisting of fully-connected multilayers for automatically extracting complex information included in the training data. The second neural network may include eight hidden layers. The number of nodes of the eight hidden layers may be 1024, 512, 256, 128, 64, 32, 16, and 8, respectively. An input layer may include 126 nodes, and an output layer may include four nodes corresponding to the number of precipitation type 30. The loss function, the activation function, and the optimizer used for the training through the second neural network may correspond to the function and the optimizer used for the training through the first neural network. In the meantime, the particular numerical value of the second neural network is merely one example for helping the understanding, and is not limited thereto.

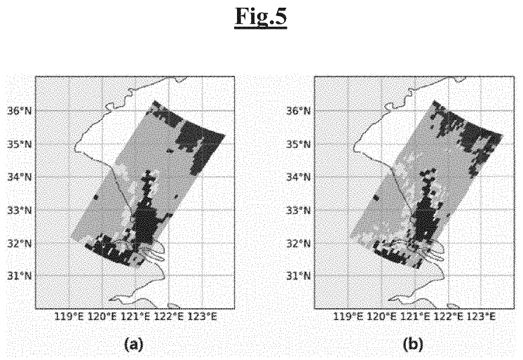

FIG. 5 is a conceptual diagram illustrating a verification result of the deep learning model according to the exemplary embodiment of the present disclosure.

(a) of FIG. 5 represents a result of the classification of the precipitation type for each pixel based on the GMI-based sensor data including all of the ground surface types by using the deep learning model according to the exemplary embodiment of the present disclosure. (b) of FIG. 5 represents an actual observation result of the same region as that of (a) of FIG. 5. Comparing (a) and (b) of FIG. 5, it can be seen that the result of the prediction of the precipitation type by the deep learning model and the actual observation result are considerably matched. That is, it can be confirmed that the deep learning model according to the exemplary embodiment of the present disclosure is capable of deriving the prediction result of the precipitation type corresponding to the actual observation result regardless of the ground surface type. Therefore, the deep learning model trained as described above may guarantee robust performance in the prediction of precipitation.

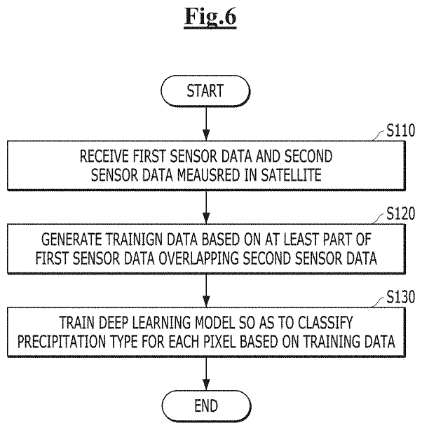

FIG. 6 is a flowchart illustrating a process of training the deep learning model by a computing device according to the exemplary embodiment of the present disclosure.

Referring to FIG. 6, in operation S110, the computing device 100 according to the exemplary embodiment of the present disclosure may receive first sensor data and second sensor data measured within different swaths measured in a satellite through communication with an external system. For example, the computing device 100 may receive the data measured in each sensor provided in the satellite in real time through the communication with the satellite. The computing device 100 may individually receive sensor data measured for each satellite according to a purpose through communication with several satellites which monitor the same region. Further, the computing device 100 may also receive data which has measured in the satellite and stored in a database server on the ground through communication with the database server.

In operation S120, the computing device 100 may perform preprocessing for generating training data based on the first sensor data and the second sensor data measured within the different swaths. The computing device 100 may overlap the first sensor data and the second sensor data based on an observation location for each pixel of the second sensor data. The computing device 100 may generate the training data based on at least a part of the first sensor data that overlaps the second sensor data. In this case, information about a brightness temperature included in the first sensor data and information about the ground surface type included in the second sensor data may be used as input characteristics of the training data. Further, information about the precipitation type included in the second sensor data may be used as a label of the training data.

In operation S130, the computing device 100 may input the training data generated through the preprocessing of operation S120 to a deep learning model, and train the deep learning model so as to classify the precipitation type for each pixel. Through the process of classifying the precipitation type for each pixel constituting the training data and comparing whether the classification result is matched with ground truth (GT) labeled on the pixel, the computing device 100 may train the deep learning model so as to classify the precipitation type for each pixel of the sensor data measured in the satellite.

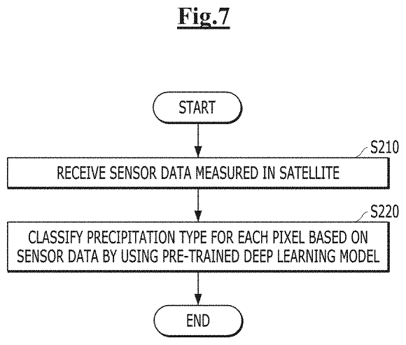

FIG. 7 is a flowchart illustrating a process of classifying a precipitation type by using the deep learning model of the computing device according to the exemplary embodiment of the present disclosure.

In FIG. 7, in operation S210, the computing device 100 according to the exemplary embodiment of the present disclosure may receive sensor data measured in a satellite through communication with an external system. In this case, the sensor data received for predicting the precipitation type by the computing device 100 is GMI-based sensor data including information about a brightness temperature, and may include an image obtained by photographing a specific earth surface. For example, the computing device 100 may receive data measured in a sensor provided in the satellite in real time through communication with a GPM satellite. Further, the computing device 100 may also receive data which has been measured in the GPM satellite and stored in a database server on the ground through communication with the database server.

In operation S220, the computing device 100 may predict the precipitation type for each pixel of the sensor data based on the sensor data received through operation S210 by using a pre-trained deep learning model. The computing device 100 may classify the precipitation type for each pixel by inputting the GMI-based sensor data to the deep learning model. For example, the computing device 100 may input an image of a specific ground surface region photographed through the GMI to the deep learning model and classify the precipitation type into one of the four precipitation types for each pixel. In this case, the precipitation type that may be classified through the deep learning model may be one of a first type representing no rain, second type representing stratiform rain, a third type representing convective rain, and a fourth type representing simple cloud or noise. The computing device 100 may classify the four precipitation types and the precipitation region through the pre-trained deep learning model at the same time, and provide a precipitation prediction result with high accuracy.

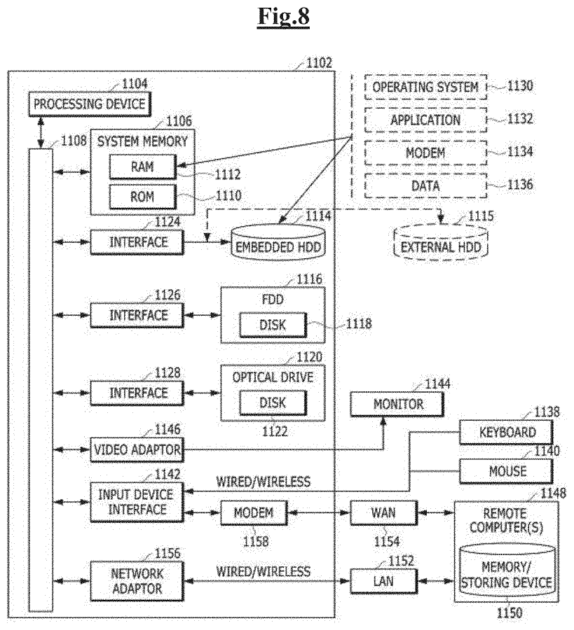

FIG. 8 is a simple and general schematic diagram for an example of a computing environment in which exemplary embodiments of the present disclosure are implementable.

The present disclosure has been described as being generally implementable by the computing device, but those skilled in the art will appreciate well that the present disclosure is combined with computer executable commands and/or other program modules executable in one or more computers and/or be implemented by a combination of hardware and software.

In general, a program module includes a routine, a program, a component, a data structure, and the like performing a specific task or implementing a specific abstract data form. Further, those skilled in the art will appreciate well that the method of the present disclosure may be carried out by a personal computer, a hand-held computing device, a microprocessor-based or programmable home appliance (each of which may be connected with one or more relevant devices and be operated), and other computer system configurations, as well as a single-processor or multiprocessor computer system, a mini computer, and a main frame computer.

The exemplary embodiments of the present disclosure may be carried out in a distribution computing environment, in which certain tasks are performed by remote processing devices connected through a communication network. In the distribution computing environment, a program module may be located in both a local memory storage device and a remote memory storage device.

The computer generally includes various computer readable media. The computer accessible medium may be any type of computer readable medium, and the computer readable medium includes volatile and non-volatile media, transitory and non-transitory media, and portable and non-portable media. As a non-limited example, the computer readable medium may include a computer readable storage medium and a computer readable transmission medium. The computer readable storage medium includes volatile and non-volatile media, transitory and non-transitory media, and portable and non-portable media constructed by a predetermined method or technology, which stores information, such as a computer readable command, a data structure, a program module, or other data. The computer readable storage medium includes a Random Access Memory (RAM), a Read Only Memory (ROM), an Electrically Erasable and Programmable ROM (EEPROM), a flash memory, or other memory technologies, a Compact Disc (CD)-ROM, a Digital Video Disk (DVD), or other optical disk storage devices, a magnetic cassette, a magnetic tape, a magnetic disk storage device, or other magnetic storage device, or other predetermined media, which are accessible by a computer and are used for storing desired information, but is not limited thereto.

The computer readable transport medium generally implements a computer readable command, a data structure, a program module, or other data in a modulated data signal, such as a carrier wave or other transport mechanisms, and includes all of the information transport media. The modulated data signal means a signal, of which one or more of the characteristics are set or changed so as to encode information within the signal. As a non-limited example, the computer readable transport medium includes a wired medium, such as a wired network or a direct-wired connection, and a wireless medium, such as sound, Radio Frequency (RF), infrared rays, and other wireless media. A combination of the predetermined media among the foregoing media is also included in a range of the computer readable transport medium.

An illustrative environment 1100 including a computer 1102 and implementing several aspects of the present disclosure is illustrated, and the computer 1102 includes a processing device 1104, a system memory 1106, and a system bus 1108. The system bus 1108 connects system components including the system memory 1106 (not limited) to the processing device 1104. The processing device 1104 may be a predetermined processor among various commonly used processors. A dual processor and other multi-processor architectures may also be used as the processing device 1104.

The system bus 1108 may be a predetermined one among several types of bus structure, which may be additionally connectable to a local bus using a predetermined one among a memory bus, a peripheral device bus, and various common bus architectures. The system memory 1106 includes a ROM 1110, and a RAM 1112. A basic input/output system (BIOS) is stored in a non-volatile memory 1110, such as a ROM, an EPROM, and an EEPROM, and the BIOS includes a basic routing helping a transport of information among the constituent elements within the computer 1102 at a time, such as starting. The RAM 1112 may also include a high-rate RAM, such as a static RAM, for caching data.

The computer 1102 also includes an embedded hard disk drive (HDD) 1114 (for example, enhanced integrated drive electronics (EIDE) and serial advanced technology attachment (SATA))—the embedded HDD 1114 being configured for exterior mounted usage within a proper chassis (not illustrated)—a magnetic floppy disk drive (FDD) 1116 (for example, which is for reading data from a portable diskette 1118 or recording data in the portable diskette 1118), and an optical disk drive 1120 (for example, which is for reading a CD-ROM disk 1122, or reading data from other high-capacity optical media, such as a DVD, or recording data in the high-capacity optical media). A hard disk drive 1114, a magnetic disk drive 1116, and an optical disk drive 1120 may be connected to a system bus 1108 by a hard disk drive interface 1124, a magnetic disk drive interface 1126, and an optical drive interface 1128, respectively. An interface 1124 for implementing an exterior mounted drive includes, for example, at least one of or both a universal serial bus (USB) and the Institute of Electrical and Electronics Engineers (IEEE) 1394 interface technology.

The drives and the computer readable media associated with the drives provide non-volatile storage of data, data structures, computer executable commands, and the like. In the case of the computer 1102, the drive and the medium correspond to the storage of random data in an appropriate digital form. In the description of the computer readable media, the HDD, the portable magnetic disk, and the portable optical media, such as a CD, or a DVD, are mentioned, but those skilled in the art will well appreciate that other types of computer readable media, such as a zip drive, a magnetic cassette, a flash memory card, and a cartridge, may also be used in the illustrative operation environment, and the predetermined medium may include computer executable commands for performing the methods of the present disclosure.

A plurality of program modules including an operation system 1130, one or more application programs 1132, other program modules 1134, and program data 1136 may be stored in the drive and the RAM 1112. An entirety or a part of the operation system, the application, the module, and/or data may also be cached in the RAM 1112. It will be well appreciated that the present disclosure may be implemented by several commercially usable operation systems or a combination of operation systems.

A user may input a command and information to the computer 1102 through one or more wired/wireless input devices, for example, a keyboard 1138 and a pointing device, such as a mouse 1140. Other input devices (not illustrated) may be a microphone, an IR remote controller, a joystick, a game pad, a stylus pen, a touch screen, and the like. The foregoing and other input devices are frequently connected to the processing device 1104 through an input device interface 1142 connected to the system bus 1108, but may be connected by other interfaces, such as a parallel port, an IEEE 1394 serial port, a game port, a USB port, an IR interface, and other interfaces.

A monitor 1144 or other types of display devices are also connected to the system bus 1108 through an interface, such as a video adaptor 1146. In addition to the monitor 1144, the computer generally includes other peripheral output devices (not illustrated), such as a speaker and a printer.

The computer 1102 may be operated in a networked environment by using a logical connection to one or more remote computers, such as remote computer(s) 1148, through wired and/or wireless communication. The remote computer(s) 1148 may be a work station, a computing device computer, a router, a personal computer, a portable computer, a microprocessor-based entertainment device, a peer device, and other general network nodes, and generally includes some or an entirety of the constituent elements described for the computer 1102, but only a memory storage device 1150 is illustrated for simplicity. The illustrated logical connection includes a wired/wireless connection to a local area network (LAN) 1152 and/or a larger network, for example, a wide area network (WAN) 1154. The LAN and WAN networking environments are general in an office and a company, and make an enterprise-wide computer network, such as an Intranet, easy, and all of the LAN and WAN networking environments may be connected to a worldwide computer network, for example, the Internet.

When the computer 1102 is used in the LAN networking environment, the computer 1102 is connected to the local network 1152 through a wired and/or wireless communication network interface or an adaptor 1156. The adaptor 1156 may make wired or wireless communication to the LAN 1152 easy, and the LAN 1152 also includes a wireless access point installed therein for the communication with the wireless adaptor 1156. When the computer 1102 is used in the WAN networking environment, the computer 1102 may include a modem 1158, is connected to a communication computing device on a WAN 1154, or includes other means setting communication through the WAN 1154 via the Internet. The modem 1158, which may be an embedded or outer-mounted and wired or wireless device, is connected to the system bus 1108 through a serial port interface 1142. In the networked environment, the program modules described for the computer 1102 or some of the program modules may be stored in a remote memory/storage device 1150. The illustrated network connection is illustrative, and those skilled in the art will appreciate well that other means setting a communication link between the computers may be used.

The computer 1102 performs an operation of communicating with a predetermined wireless device or entity, for example, a printer, a scanner, a desktop and/or portable computer, a portable data assistant (PDA), a communication satellite, predetermined equipment or place related to a wirelessly detectable tag, and a telephone, which is disposed by wireless communication and is operated. The operation includes a wireless fidelity (Wi-Fi) and Bluetooth wireless technology at least. Accordingly, the communication may have a pre-defined structure, such as a network in the related art, or may be simply ad hoc communication between at least two devices.

The Wi-Fi enables a connection to the Internet and the like even without a wire. The Wi-Fi is a wireless technology, such as a cellular phone, which enables the device, for example, the computer, to transmit and receive data indoors and outdoors, that is, in any place within a communication range of a base station. A Wi-Fi network uses a wireless technology, which is called IEEE 802.11 (a, b, g, etc.) for providing a safe, reliable, and high-rate wireless connection. The Wi-Fi may be used for connecting the computer to the computer, the Internet, and the wired network (IEEE 802.3 or Ethernet is used). The Wi-Fi network may be operated at, for example, a data rate of 11 Mbps (802.11a) or 54 Mbps (802.11b) in an unauthorized 2.4 and 5 GHz wireless band, or may be operated in a product including both bands (dual bands).

In the meantime, according to an exemplary embodiment of the present disclosure, a computer readable medium storing a data structure is disclosed.

The data structure may refer to organization, management, and storage of data that enable efficient access and modification of data. The data structure may refer to organization of data for solving a specific problem (for example, data search, data storage, and data modification in the shortest time). The data structure may also be defined with a physical or logical relationship between the data elements designed to support a specific data processing function. A logical relationship between data elements may include a connection relationship between user defined data elements. A physical relationship between data elements may include an actual relationship between the data elements physically stored in a computer readable storage medium (for example, a permanent storage device). In particular, the data structure may include a set of data, a relationship between data, and a function or a command applicable to data. Through the effectively designed data structure, the computing device may perform a calculation while minimally using resources of the computing device. In particular, the computing device may improve efficiency of calculation, reading, insertion, deletion, comparison, exchange, and search through the effectively designed data structure.

The data structure may be divided into a linear data structure and a non-linear data structure according to the form of the data structure. The linear data structure may be the structure in which only one data is connected after one data. The linear data structure may include a list, a stack, a queue, and a deque. The list may mean a series of dataset in which order exists internally. The list may include a linked list. The linked list may have a data structure in which data is connected in a method in which each data has a pointer and is linked in a single line. In the linked list, the pointer may include information about the connection with the next or previous data. The linked list may be expressed as a single linked list, a double linked list, and a circular linked list according to the form. The stack may have a data listing structure with limited access to data. The stack may have a linear data structure that may process (for example, insert or delete) data only at one end of the data structure. The data stored in the stack may have a data structure (Last In First Out, LIFO) in which the later the data enters, the sooner the data comes out. The queue is a data listing structure with limited access to data, and may have a data structure (First In First Out, FIFO) in which the later the data is stored, the later the data comes out, unlike the stack. The deque may have a data structure that may process data at both ends of the data structure.

The non-linear data structure may be the structure in which the plurality of pieces of data is connected after one data. The non-linear data structure may include a graph data structure. The graph data structure may be defined with a vertex and an edge, and the edge may include a line connecting two different vertexes. The graph data structure may include a tree data structure. The tree data structure may be the data structure in which a path connecting two different vertexes among the plurality of vertexes included in the tree is one. That is, the tree data structure may be the data structure in which a loop is not formed in the graph data structure.

Throughout the present specification, a calculation model, a nerve network, the network function, and the neural network may be used with the same meaning. Hereinafter, the terms of the calculation model, the nerve network, the network function, and the neural network are unified and described with a neural network. The data structure may include a neural network. Further, the data structure including the neural network may be stored in a computer readable medium. The data structure including the neural network may also include data pre-processed by the processing by the neural network, data input to the neural network, a weight of the neural network, a hyper-parameter of the neural network, data obtained from the neural network, an active function associated with each node or layer of the neural network, and a loss function for training of the neural network. The data structure including the neural network may include predetermined configuration elements among the disclosed configurations. That is, the data structure including the neural network may also include all or a predetermined combination of preprocessed data for processing by the neural network, data input to the neural network, a weight of the neural network, a hyper-parameter of the neural network, data obtained from the neural network, an active function associated with each node or layer of the neural network, and a loss function for training of the neural network. In addition to the foregoing configurations, the data structure including the neural network may include predetermined other information determining a characteristic of the neural network. Further, the data structure may include all type of data used or generated in a computation process of the neural network, and is not limited to the foregoing matter. The computer readable medium may include a computer readable recording medium and/or a computer readable transmission medium. The neural network may be formed of a set of interconnected calculation units which are generally referred to as “nodes”. The “nodes” may also be called “neurons”. The neural network consists of one or more nodes.

The data structure may include data input to the neural network. The data structure including the data input to the neural network may be stored in the computer readable medium. The data input to the neural network may include training data input in the training process of the neural network and/or input data input to the training completed neural network. The data input to the neural network may include data that has undergone pre-processing and/or data to be pre-processed. The pre-processing may include a data processing process for inputting data to the neural network. Accordingly, the data structure may include data to be pre-processed and data generated by the pre-processing. The foregoing data structure is merely an example, and the present disclosure is not limited thereto.

The data structure may include a weight of the neural network. (in the present specification, weights and parameters may be used with the same meaning.) Further, the data structure including the weight of the neural network may be stored in the computer readable medium. The neural network may include a plurality of weights. The weight is variable, and in order for the neural network to perform a desired function, the weight may be varied by a user or an algorithm. For example, when one or more input nodes are connected to one output node by links, respectively, the output node may determine a data value output from the output node based on values input to the input nodes connected to the output node and the weight set in the link corresponding to each of the input nodes. The foregoing data structure is merely an example, and the present disclosure is not limited thereto.

For a non-limited example, the weight may include a weight varied in the neural network training process and/or the weight when the training of the neural network is completed. The weight varied in the neural network training process may include a weight at a time at which a training cycle starts and/or a weight varied during a training cycle. The weight when the training of the neural network is completed may include a weight of the neural network completing the training cycle. Accordingly, the data structure including the weight of the neural network may include the data structure including the weight varied in the neural network training process and/or the weight when the training of the neural network is completed. Accordingly, it is assumed that the weight and/or a combination of the respective weights are included in the data structure including the weight of the neural network. The foregoing data structure is merely an example, and the present disclosure is not limited thereto.

The data structure including the weight of the neural network may be stored in the computer readable storage medium (for example, a memory and a hard disk) after undergoing a serialization process. The serialization may be the process of storing the data structure in the same or different computing devices and converting the data structure into a form that may be reconstructed and used later. The computing device may serialize the data structure and transceive the data through a network. The serialized data structure including the weight of the neural network may be reconstructed in the same or different computing devices through deserialization. The data structure including the weight of the neural network is not limited to the serialization. Further, the data structure including the weight of the neural network may include a data structure (for example, in the non-linear data structure, B-Tree, Trie, m-way search tree, AVL tree, and Red-Black Tree) for improving efficiency of the calculation while minimally using the resources of the computing device. The foregoing matter is merely an example, and the present disclosure is not limited thereto.

The data structure may include a hyper-parameter of the neural network. The data structure including the hyper-parameter of the neural network may be stored in the computer readable medium. The hyper-parameter may be a variable varied by a user. The hyper-parameter may include, for example, a learning rate, a cost function, the number of times of repetition of the training cycle, weight initialization (for example, setting of a range of a weight value to be weight-initialized), and the number of hidden units (for example, the number of hidden layers and the number of nodes of the hidden layer). The foregoing data structure is merely an example, and the present disclosure is not limited thereto.

Those skilled in the art may appreciate that information and signals may be expressed by using predetermined various different technologies and techniques. For example, data, indications, commands, information, signals, bits, symbols, and chips referable in the foregoing description may be expressed with voltages, currents, electromagnetic waves, magnetic fields or particles, optical fields or particles, or a predetermined combination thereof.

Those skilled in the art will appreciate that the various illustrative logical blocks, modules, processors, means, circuits, and algorithm operations described in relationship to the exemplary embodiments disclosed herein may be implemented by electronic hardware (for convenience, called “software” herein), various forms of program or design code, or a combination thereof. In order to clearly describe compatibility of the hardware and the software, various illustrative components, blocks, modules, circuits, and operations are generally illustrated above in relation to the functions of the hardware and the software. Whether the function is implemented as hardware or software depends on design limits given to a specific application or an entire system. Those skilled in the art may perform the function described by various schemes for each specific application, but it shall not be construed that the determinations of the performance depart from the scope of the present disclosure.

Various exemplary embodiments presented herein may be implemented by a method, a device, or a manufactured article using a standard programming and/or engineering technology. A term “manufactured article” includes a computer program, a carrier, or a medium accessible from a predetermined computer-readable storage device. For example, the computer-readable storage medium includes a magnetic storage device (for example, a hard disk, a floppy disk, and a magnetic strip), an optical disk (for example, a CD and a DVD), a smart card, and a flash memory device (for example, an EEPROM, a card, a stick, and a key drive), but is not limited thereto. Further, various storage media presented herein include one or more devices and/or other machine-readable media for storing information.

It shall be understood that a specific order or a hierarchical structure of the operations included in the presented processes is an example of illustrative accesses. It shall be understood that a specific order or a hierarchical structure of the operations included in the processes may be rearranged within the scope of the present disclosure based on design priorities. The accompanying method claims provide various operations of elements in a sample order, but it does not mean that the claims are limited to the presented specific order or hierarchical structure.

The description of the presented exemplary embodiments is provided so as for those skilled in the art to use or carry out the present disclosure. Various modifications of the exemplary embodiments may be apparent to those skilled in the art, and general principles defined herein may be applied to other exemplary embodiments without departing from the scope of the present disclosure. Accordingly, the present disclosure is not limited to the exemplary embodiments suggested herein, and shall be interpreted within the broadest meaning range consistent to the principles and new characteristics presented herein.

What is claimed is:

1. A method of classifying a precipitation type based on deep learning performed by a computing device including at least one processor, the method comprising:
receiving first sensor data and second sensor data measured in a satellite; and
generating training data based on at least a part of the first sensor data overlapping the second sensor data.

2. The method of claim 1, wherein the second sensor data includes data measured within a swath in a relatively narrower range than the first sensor data.

3. The method of claim 2, wherein the first sensor data includes data measured through a microwave image sensor of a Global Precipitation Measurement (GPM) satellite, and
the second sensor data includes data measured through a Dual-frequency Precipitation Radar (DPR) sensor.

4. The method of claim 1, wherein the generating of the training data based on at least a part of the first sensor data overlapping the second sensor data includes:
overlapping the first sensor data and the second sensor data based on an observation location for each pixel of the second sensor data; and
generating the training data based on at least a part of the first sensor data that have overlapped based on the observation location for each pixel of the second sensor data.

5. The method of claim 4, wherein the generating of the training data based on at least a part of the first sensor data overlapping the second sensor data further includes generating a subset of the training data based on a ratio of pixels in which precipitation exists included in the training data.

6. The method of claim 1, wherein the training data includes:
a first input characteristic representing a brightness temperature derived from at least a part of the first sensor data overlapping the second sensor data; and
a second input characteristic representing a ground surface type derived from the second sensor data.

7. The method of claim 6, wherein the first input characteristic includes information about the brightness temperature divided based on a measurement frequency and a polarization direction of the first sensor data.

8. The method of claim 6, wherein the ground surface type includes at least one of marine, land, coast, and in-land water.

9. The method of claim 1, wherein the training data is labeled with information about a precipitation type derived from the second sensor data.

10. The method of claim 9, wherein the precipitation type includes at least one of:
a first type representing no rain;
a second type representing stratiform rain;
a third type representing convective rain; and
a fourth type representing cloud or noise.

11. The method of claim 1, further comprising:
training a deep learning model so as to classify the precipitation type for each pixel based on the training data.

12. A method of classifying a precipitation type based on deep learning performed by a computing device including at least one processor, the method comprising:
receiving sensor data measured in a satellite; and
classifying a precipitation type for each pixel based on the sensor data by using a pre-trained deep learning model.

13. The method of claim 12, wherein the deep learning model is pre-trained based on first sensor data measured in the satellite and second sensor data measured within a swath in a relatively narrower range than the first sensor data.

14. A computing device for classifying a precipitation type based on deep learning, the computing device comprising:
a processor including at least one core;
a memory including program codes executable in the processor; and
a network unit configured to receive sensor data measured in a satellite,
wherein the processor is configured to generate training data based on at least a part of first sensor data measured in a satellite, the first sensor data overlapping second sensor data measured in the satellite.

15. A non-transitory computer readable medium storing codes related to a training process updating at least a part of parameters of a neural network, wherein an operation of the neural network is at least partially based on the parameter, and the codes comprise:
code for receiving first sensor data and second sensor data measured in a satellite; and
code for generating training data based on at least a part of the first sensor data overlapping the second sensor data.
